(19) United States
(12) Patent Application Publication
(10) Pub. No.: US 2006/0280955 A1
(43) Pub. Date: Dec. 14, 2006

(54) Corrosion resistant sealant for EBC of silicon-containing substrate and processes for preparing same

(76) Inventors: Irene Spitsberg, Loveland, OH (US); Brian Thomas Hazel, West Chester, OH (US)

Correspondence Address: JAGTIANI + GUTTAG, 10363-A DEMOCRACY LANE, FAIRFAX, VA, 22030, US

(21) Appl. No.: 11/150,100

(22) Filed: Jun. 13, 2005

(51) Int. Cl. B32B 13/04; B32B 9/00; B32B 19/00; B05D 5/12; B05D 1/36; B05D 1/08

(52) U.S. Cl. 428/446; 428/701; 428/702; 428/698; 427/402; 427/126.1; 427/446

(57) ABSTRACT

An article comprising a silicon-containing substrate, an environmental barrier coating (EBC) overlying the substrate, wherein the EBC comprises an outer alkaline earth aluminosilicate barrier layer; and a corrosion resistant alumina/aluminate sealant for the outer barrier layer. A process is also provided for forming a corrosion resistant alumina/aluminate sealant layer over the outer barrier layer of the EBC. Also provided is an alternative process for treating a porous outer barrier layer with a liquid composition comprising an corrosion resistant alumina/aluminate sealant precursor to infiltrate the porous outer barrier layer with the alumina/aluminate sealant precursor in an amount sufficient to provide, when converted to the corrosion resistant alumina/aluminate sealant, protection of the environmental barrier coating against environmental attack; and converting the infiltrated alumina/aluminate sealant precursor within the porous outer barrier layer to the corrosion resistant alumina/aluminate sealant.

### BACKGROUND OF THE INVENTION

This invention broadly relates to an article comprising a corrosion resistant alumina/aluminate sealant for the outer alkaline earth aluminosilicate barrier layer of an environmental barrier coating (EBC) for a silicon-containing substrate. This invention further broadly relates to processes for forming the alumina/aluminate sealant for the outer barrier layer of the EBC.

Higher operating temperatures for gas turbine engines are continuously sought in order to increase their efficiency. However, as operating temperatures increase, the high temperature durability of the components of the engine must correspondingly increase. Significant advances in high temperature capabilities have been achieved through formulation of iron, nickel and cobalt-base superalloys. While superalloys have found wide use for gas turbine components used throughout gas turbine engines, and especially the higher temperature sections, alternative lighter weight substrate materials have been proposed and sought.

Ceramic materials containing silicon, such as those comprising silicon carbide (SiC) as a matrix material and/or as a reinforcing material (e.g., as fibers) are currently being used as substrate materials for higher temperature applications, such as gas turbine engines, heat exchangers, internal combustion engines, etc. These silicon-containing matrix/reinforcing materials are commonly referred to as ceramic matrix composites (CMCs). These silicon-containing materials used as matrix materials and/or as reinforcing materials can decrease the weight yet maintain the strength and durability of turbine components comprising such substrates, and are currently being considered for many gas turbine components used in higher temperature sections of gas turbine engines, such as turbine components comprising airfoils (e.g., compressors, turbines, vanes, etc.), combustors, and other turbine components for which reduced weight is desirable.

As operating temperatures increase, the high temperature durability of such CMC materials must also correspondingly increase. Such coatings should provide environmental protection by inhibiting the major mechanism for degradation of silicon-containing materials in a corrosive water-containing environment, namely, the formation of volatile silicon monoxide (SiO) and silicon hydroxide (Si(OH)₄) products. Consequently, a necessary requirement of an environmental barrier coating (EBC) system for a silicon-containing substrate is stability in high temperature environments containing water vapors. Other important properties for these EBCs systems can include a coefficient of thermal expansion (CTE) compatible with the silicon-containing substrate, low permeability for oxidants, low thermal conductivity and chemical compatibility with the silicon-containing substrate and overlaying silica scale typically formed by oxidation.

Various single-layer and multilayer EBC systems have been investigated, but each has exhibited shortcomings relating to environmental protection and compatibility with silicon-containing substrates. For example, EBC systems have been suggested for protecting silicon-containing CMC substrates from oxidation at high temperatures and degradation in the presence of aqueous environments (e.g., steam). These EBC systems include those comprising mullites (3Al₂O₃.2SiO₂) disclosed in, for example, commonly-assigned U.S. Pat. No. 6,129,954 (Spitsberg et al.), issued Oct. 10, 2000, and U.S. Pat. No. 5,869,146 (McCluskey et al.), issued Feb. 9, 1999. Other EBC systems comprising barium strontium aluminosilicate (BSAS), with or without mullite, and with or without additional thermal barrier coatings, are disclosed in, for example, commonly-assigned U.S. Pat. No. 5,985,470 (Spitsberg et al.), issued Nov. 16, 1999; U.S. Pat. No. 6,444,335 (Wang et al.), issued Sep. 3, 2002; U.S. Pat. No. 6,607,852 (Spitsberg et al.), issued Aug. 19, 2003; and U.S. Pat. No. 6,410,148 (Eaton et al.), issued Jun. 25, 2002.

One version of a steam-resistant EBC system comprises essentially three-layers of: (1) a silicon bond coat layer overlaying and adjacent the silicon-containing substrate; (2) a combination mullite-BSAS (e.g., 80% mullite-20% BSAS) transition layer overlaying and adjacent the bond coat layer; and (3) an outer barrier layer comprising BSAS overlaying and adjacent the transition layer. See, e.g., commonly-assigned U.S. Pat. No. 6,410,148 (Eaton et al.), issued Jun. 25, 2002. The silicon bond coat layer provides good adhesion of the EBC to the silicon-containing substrate (e.g., a SiC/SiC CMC substrate) and can also function as a sacrificial oxidation layer. The mullite-BSAS transition layer prevents rapid reaction between the outer barrier layer comprising BSAS and the silica scale that typically forms on the silicon bond coat layer. The outer barrier layer comprising BSAS is relatively resistant to steam and other high temperature aqueous environments.

The BSAS-containing outer barrier layer of the EBC may not be sufficiently resistant to environmental attack caused by other corrosive agents. For example, corrosive environments comprising sulfates and/or chloride salts, oxides of calcium, magnesium, etc., or mixtures thereof such as mixed calcium-magnesium-aluminum-silicon-oxide systems commonly referred to as “CMAS” (see, for example, commonly assigned U.S. Pat. No. 5,660,885 (Hasz et al.), issued Aug. 26, 1997, which discusses the corrosion problems caused by CMAS) can attack the BSAS-containing outer barrier layer, and thus contribute to the degradation of the EBC.

These steam-resistant EBCs comprising BSAS are also typically deposited on the silicon-containing CMC substrates by thermal spray techniques such as plasma spraying. Controlling coating thickness is difficult to achieve with plasma spraying. In particular, plasma spraying tends to form relatively thick coatings or layers that may not be suitable for certain applications, e.g., turbine airfoils, where thinner coatings are needed. Plasma-spray application methods can also impart relatively high roughness values to the resultant coating. This higher coating roughness requires thicker coatings to be deposited with this higher roughness being reduced by a post-coating operation such as polishing or tumbling, resulting in increased processing costs.

Accordingly, it would be desirable to be able to provide an EBC for silicon-containing substrates that: (1) is resistant to environmental attack caused by other corrosive agents besides steam, e.g., sulfates and/or chloride salts, or oxides of calcium, magnesium, etc., or mixtures thereof, such as CMAS, etc.; and/or (2) can be formed to provide coating thicknesses that are thinner than those provided by thermal spray techniques such as plasma spray.

### BRIEF DESCRIPTION OF THE INVENTION

An embodiment of this invention is broadly directed at an article comprising:
a silicon-containing substrate;
an environmental barrier coating overlaying the substrate, wherein the environmental barrier coating comprises an outer alkaline earth aluminosilicate barrier layer; and
a corrosion resistant alumina/aluminate sealant for the outer barrier layer.

Another embodiment of this invention is broadly directed at a process comprising the following steps:
(a) providing a silicon-containing substrate having an overlaying environmental barrier coating comprising an outer alkaline earth aluminosilicate barrier layer; and
(b) forming a corrosion resistant alumina/aluminate sealant layer over the outer barrier layer.

Another embodiment of this invention is broadly directed at a process comprising the following steps:
(a) providing a silicon-containing substrate having an overlaying environmental barrier coating comprising a porous outer alkaline earth aluminosilicate barrier layer;
(b) treating the porous outer barrier layer with a liquid composition comprising a corrosion resistant alumina/aluminate sealant precursor to infiltrate the porous outer barrier layer with the alumina/aluminate sealant precursor in an amount sufficient to provide, when converted to the corrosion alumina/aluminate sealant, protection of the environmental barrier coating against environmental attack; and
(c) converting the infiltrated alumina/aluminate sealant precursor within the porous outer barrier layer to the corrosion resistant alumina/aluminate sealant.

The embodiments of the article and processes of this invention provide a number of advantages and benefits with regard to articles comprising silicon-containing substrates having environmental barrier coating (EBC) systems with an outer alkaline earth aluminosilicate barrier layer. The corrosion resistant alumina/aluminate sealant for the outer alkaline earth aluminosilicate barrier layer enables the EBC to be more resistant to environmental attack caused by other corrosive agents such as sulfates and/or chlorides of calcium, magnesium, sodium, etc., or mixtures thereof (e.g., from sea salt), or by oxides of calcium, magnesium, etc., or mixtures thereof (e.g., CMAS). The embodiments of the processes of this invention can also form the corrosion resistant alumina/aluminate sealant as a relatively thin layer, or can infiltrate the sealant into a porous outer alkaline earth aluminosilicate barrier layer of the EBC to provide protection against environmental attack caused by these corrosive agents.

### BRIEF DESCRIPTION OF THE DRAWINGS

FIG. 1 is a perspective view of a turbine blade for which embodiments of this invention comprising the corrosion resistant alumina/aluminate sealant, environmental barrier coating (EBC), and silicon-containing substrate are useful.

FIG. 2 is an enlarged sectional view through the airfoil portion of the turbine blade of FIG. 1, taken along line 2-2, showing an embodiment of the article of this invention comprising a silicon-containing substrate, the EBC system, the corrosion resistant alumina/aluminate sealant layer, and optional thermal barrier coating (TBC).

### DETAILED DESCRIPTION OF THE INVENTION

As used herein, the term “environmental barrier coating” (hereafter “EBC”) refers to EBCs that typically provide a protective barrier at least against environmental attack caused by high temperature, aqueous environments (e.g., steam). The EBCs comprise an outer alkaline earth aluminosilicate barrier layer, plus one or more optional layers. The outer alkaline earth aluminosilicate barrier layer of the EBC can have a structure that is sufficiently porous to enable infiltration with a precursor of the corrosion resistant alumina/aluminate material, as described hereafter.

As used herein, the term “alkaline earth aluminosilicate barrier layer” refers to a barrier layer that is typically resistant to environmental attack caused by high temperature, aqueous environments (e.g., steam), and which typically consists essentially of an alkaline earth aluminosilicate, e.g., comprises at least about 90% of an alkaline earth aluminosilicate, typically at least about 95% of an alkaline earth aluminosilicate, and more typically at least about 99% of an alkaline earth aluminosilicate.

As used herein, the term “alkaline earth aluminosilicate” (referred to hereafter as “AEASs”) refers to alkaline earth aluminosilicates that typically comprise barium strontium aluminosilicates (referred to hereafter as “BSASs”). Usually, the BSASs comprise from about 0.00 to about 1.00 moles BaO, from about 0.00 to about 1.00 moles SrO, about 1.00 moles Al₂O₃ and about 2.00 moles SiO₂, wherein the combined moles of BaO and SrO is about 1.00 mole. Typically, the BSASs comprise from about 0.10 to about 0.90 moles (more typically from about 0.25 to about 0.75 moles) BaO, from about 0.10 to about 0.90 moles (more typically from about 0.25 to about 0.75 moles) SrO, about 1.00 moles Al₂O₃ and about 2.00 moles SiO₂, wherein the combined moles of BaO and SrO is about 1.00 moles. One such BSAS comprises about 0.75 moles BaO, about 0.25 moles SrO, about 1.00 moles Al₂O₃ and about 2.00 moles SiO₂. See U.S. Pat. No. 6,410,148 (Eaton et al.), issued Jun. 25, 2002, especially column 3, lines 6-25, the relevant portions of which are herein incorporated by reference. Another version of a BSAS (hereafter referred to as “single phase BSAS”) that is less susceptible to degradation and volatilization in the presence of high temperature aqueous environments (e.g., steam) comprises at least an outer surface region that consists essentially of stoichiometric crystalline phase(s) of BSAS and is substantially free of a nonstoichiometric second crystalline phase of BSAS. See commonly assigned copending U.S. patent application Ser. No. 10/709,288 (Spitsberg et al.), filed Apr. 27, 2004, the relevant portions of which are incorporated by reference. As used herein with reference to these single phase BSASs, the term “substantially free” means no more than 10 volume percent, and typically no more than 5 volume percent, of the nonstoichiometric second crystalline phase of BSAS is present in the BSAS. This nonstoichiometric second crystalline phase of BSAS is a lamella phase that contains roughly an equamolar ratio of BaO/SrO, Al₂O₃, and SiO₂, and thus differs from stoichiometric BSAS (i.e., molar ratio 0.75BaO:0.25SrO:Al₂O₃:2SiO₂; molar percent 18.75BaO:6.25SrO:25Al₂O₃:50 SiO₂). As such, this second BSAS phase contains a substoichiometric amount of silica. In addition, this second BSAS phase tends to be strontium-rich, i.e., the SrO species comprise greater than about 25 molar percent of the combined BaO+SrO content in this second BSAS phase. Barrier layers comprising these single phase BSASs can be obtained by carrying out deposition (e.g., by spraying a powder that comprises more than about 50 molar percent SiO₂) of the materials, followed by heat treatment steps that provide at least an outer surface region that consists essentially of the first stoichiometric crystalline BSAS phase that is substantially free of the second nonstoichiometric crystalline BSAS phase. See commonly assigned copending U.S. patent application Ser. No. 10/709,288 (Spitsberg et al.), filed Apr. 27, 2004, the relevant portions of which are incorporated by reference.

As used herein, the term “corrosion resistant alumina/aluminate sealant” refers to a sealant comprising a corrosion resistant alumina/aluminate material that protects the outer alkaline earth aluminosilicate barrier layer from environmental attack that can be caused by corrosive agents such as sulfates and/or chlorides of calcium, magnesium, sodium, etc., or mixtures thereof (e.g., from sea salt), oxides of calcium, magnesium, etc., or mixtures thereof, such as a contaminant composition comprising mixed calcium-magnesium-aluminum-silicon-oxide systems (Ca—Mg—Al—SiO), that are commonly referred to as “CMAS,” etc. Certain corrosion resistant sealants (i.e., those comprising corrosion resistant aluminates) may also provide protection against environmental attack caused by high temperature aqueous environments such as steam (e.g., are steam-resistant). The sealant can be in any form that protects the outer alkaline earth aluminosilicate barrier layer from such environmental attack, and especially from corrosive agents, into or through the EBC, as well as protecting the other underlying layers of the EBC (e.g., reaction barrier layers, inner silicon/silica scale bond coat layers, etc.), and the silicon-containing substrate. For example, the sealant can typically be formed as a dense layer (as described hereafter) comprising the corrosion resistant alumina/aluminate material that overlies the outer alkaline earth aluminosilicate barrier layer and effectively seals the outer alkaline earth aluminosilicate barrier layer against environmental attack by corrosive agents. Alternatively, where the outer alkaline earth aluminosilicate barrier layer has a sufficiently porous structure, the sealant can be formed (as described hereafter) by infiltrating a precursor of the corrosion resistant alumina/aluminate material (e.g., an aluminum alkoxide for forming alpha-alumina) into the porous outer alkaline earth aluminosilicate barrier layer, and then converting the precursor within the porous outer alkaline earth aluminosilicate barrier layer to the corrosion resistant alumina/aluminate material such that the corrosion resistant alumina/aluminate material effectively seals the porous outer alkaline earth aluminosilicate barrier layer against environmental attack, combines with the alkaline earth aluminosilicate in the porous outer barrier layer (e.g., during conversion of the precursor) to form a sintered composite that is resistant to environmental attack, etc.

As used herein, the term “corrosion resistant alumina/aluminate” refers to an alumina/aluminate material that is resistant to degradation by environmental attack caused by sulfates and/or chlorides of calcium, magnesium, sodium, etc., or mixtures thereof (e.g., from sea salt), or by oxides of calcium, magnesium, etc., or mixtures thereof, such as a contaminant composition comprising mixed calcium-magnesium-aluminum-silicon-oxide systems (Ca—Mg—Al—SiO), such as “CMAS,” etc., and optionally high temperature aqueous environments such as steam (e.g., is steam-resistant). Suitable corrosion resistant alumina/aluminate materials for use herein include alpha alumina, calcium aluminate (e.g., CaAl₂O₄), tantalum aluminate (e.g., TaAlO₄), niobium aluminate (e.g., NbAlO₄), scandium aluminate, yttrium aluminate, aluminates of rare earths (lanthanum aluminate, dysprosium aluminate, holmium aluminate, erbium aluminate, thulium aluminate, ytterbium aluminate, lutetium aluminate, cerium aluminate, praseodymium aluminate, neodymium aluminate, promethium aluminate, samarium aluminate, europium aluminate, gadolinium aluminate, terbium aluminate, etc.), etc., and compatible combinations thereof. In addition to protecting against environmental attack caused by corrosive agents, the aluminates can provide resistance against environmental attack caused by high temperature aqueous environments such as steam (i.e., is steam-resistant). In this regard, calcium aluminate is a particularly suitable aluminate because of its relatively low CTE (about 6) and relatively high resistance to attack by steam.

As used herein, the term “silicon-containing substrate” refers to any silicon-containing-substrate, including those comprising silicon-containing ceramic materials, metal suicides (if compositionally different from those comprising the silicide-containing bond coat layer), or combinations of such silicon-containing ceramic materials and silicon metal alloys. The silicon-containing substrate can comprise a substantially continuous matrix of silicon-containing materials, can be a composite comprising a continuous matrix of silicon-containing materials reinforced with discrete elements such as fibers, particles, etc. dispersed, embedded, etc., in the continuous matrix, etc. The discrete elements such as fibers, particles, etc., can be formed from silicon-containing ceramic materials, or can be formed from other materials, e.g., carbon fibers. Such combinations of dispersed, embedded, etc., fibers, particles, etc., in a continuous matrix of silicon-containing ceramics are typically referred to as ceramic matrix composites or CMCs. Typical CMCs comprise a continuous silicon-containing ceramic matrix that is fiber reinforced, usually with silicon-based fibers. These reinforcing fibers typically include a coating material that fully covers the fiber surfaces to impart and maintain structural integrity of the composite material systems. Typical fiber coating materials include boron nitride, silicon nitride, silicon carbide, carbon, etc. Suitable silicon-containing ceramic materials include silicon carbide, silicon nitride, silicon carbide nitride, silicon oxynitride, silicon aluminum oxynitride, etc., or combinations thereof. Suitable metal silicides useful as silicon-containing substrates include molybdenum silicides, niobium silicides, iron silicides, etc, or combinations thereof. Illustrative silicon-containing substrates suitable for use herein include silicon carbide coated silicon carbide fiber-reinforced silicon carbide particles and a silicon matrix, a carbon fiber-reinforced silicon carbide matrix, a silicon carbide fiber-reinforced silicon nitride matrix, etc.

As used herein, the term “thermal barrier coating” (hereafter “TBC”) refers to those coatings that reduce heat flow to the EBC, silicon-containing substrate, etc., of the article, i.e., form a thermal barrier, and which comprise ceramic materials that have a melting point that is typically at least about 2600° F. (1426° C.), and more typically in the range of from about 3450° to about 4980° F. (from about 1900° to about 2750° C.). Suitable ceramic materials for thermal barrier coatings include, aluminum oxide (alumina), i.e., those compounds and compositions comprising Al₂O₃, including unhydrated and hydrated forms, various zirconias, in particular phase-stabilized zirconias (e.g., zirconia blended with various stabilizer metal oxides such as yttrium oxides), such as yttria-stabilized zirconias, ceria-stabilized zirconias, calcia-stabilized zirconias, scandia-stabilized zirconias, magnesia-stabilized zirconias, india-stabilized zirconias, ytterbia-stabilized zirconias, etc., as well as mixtures of such stabilized zirconias. See, for example, Kirk-Othmer's Encyclopedia of Chemical Technology, 3rd Ed., Vol. 24, pp. 882-883 (1984) for a description of suitable zirconias. Suitable yttria-stabilized zirconias can comprise from about 1 to about 20% yttria (based on the combined weight of yttria and zirconia), and more typically from about 3 to about 10% yttria. These phase-stabilized zirconias can further include one or more of a second metal (e.g., a lanthanide or actinide) oxide such as dysprosia, erbia, europia, gadolinia, neodymia, praseodymia, urania, and hafnia to further reduce thermal conductivity of the thermal barrier coating. See U.S. Pat. No. 6,025,078 (Rickerby et al.), issued Feb. 15, 2000 and U.S. Pat. No. 6,333,118 (Alperine et al.), issued Dec. 21, 2001, both of which are incorporated by reference. Suitable ceramic materials for thermal barrier coatings also include pyrochlores of general formula A₂B₂O₇ where A is a metal having a valence of 3+ or 2+ (e.g., gadolinium, aluminum, cerium, lanthanum or yttrium) and B is a metal having a valence of 4+ or 5+ (e.g., hafnium, titanium, cerium or zirconium) where the sum of the A and B valences is 7. Representative materials of this type include gadolinium-zirconate, lanthanum titanate, lanthanum zirconate, yttrium zirconate, lanthanum hafnate, cerium zirconate, aluminum cerate, cerium hafnate, aluminum hafnate and lanthanum cerate. See U.S. Pat. No. 6,117,560 (Maloney), issued Sep. 12, 2000; U.S. Pat. No. 6,177,200 (Maloney), issued Jan. 23, 2001; U.S. Pat. No. 6,284,323 (Maloney), issued Sep. 4, 2001; U.S. Pat. No. 6,319,614 (Beele), issued Nov. 20, 2001; and U.S. Pat. No. 6,387,526 (Beele), issued May 14, 2002, all of which are incorporated by reference.

As used herein, the term “CTE” refers to the coefficient of thermal expansion of a material, and is typically defined in units of 10⁻⁶/° F. or 10⁻⁶/° C.

As used herein, the term “comprising” means various compositions, compounds, components, coatings, substrates, layers, steps, etc., can be conjointly employed in this invention. Accordingly, the term “comprising” encompasses the more restrictive terms “consisting essentially of” and “consisting of.”

All amounts, parts, ratios and percentages used herein are by weight unless otherwise specified.

The embodiments of article and processes of this invention are based on the discovery that EBC systems for silicon-containing substrates, including those comprising outer alkaline earth aluminosilicate (e.g., BSAS)-containing barrier layers, may not be sufficiently resistant to environmental attack caused by corrosive agents such as sulfate and/or chloride salts, as well as oxides such as CMAS. Because of environmental attack caused by these corrosive agents, the BSAS-containing outer barrier layer of the EBC can provide pathways and interfaces throughout the thickness of the EBC, thus enabling these corrosive agents, as well as steam, to penetrate more easily and completely through EBC. Over time, the rate of degradation of the EBC is typically accelerated because these corrosive agents (as well as steam) do not simply attack the surface of the EBC (e.g., by bulk diffusion), but instead pervasively attack the EBC throughout because of the pathways and interfaces created in the EBC.

Besides accelerating the rate of environmental attack, these porous pathways and interfaces formed in the EBC can cause other adverse effects. The deleterious species (e.g., corrosive agents, etc.) that pass though the entire thickness of the EBC can additionally reach and adversely affect less corrosion resistant layers of the EBC, such as mullite reaction barrier layers and silicon/silica scale bond coat layers, and potentially the silicon-containing substrate. For example, the deleterious species that reach the bond coat layer can adversely affect the interface between the bond coat layer and the other overlaying layers of the EBC. As a result, premature spallation of the overlaying layers of the EBC, in whole or in part, from the underlying bond coat layer can occur.

The embodiments of the article and processes of this invention solves these problems caused by the attack of the outer BSAS-containing barrier layer of these prior EBCs by these corrosive agents (e.g., sulfate or chloride salts, and/or oxides such as CMAS, etc.) by providing the outer BSAS-containing layer with a corrosion resistant alumina/aluminate sealant. The alumina/aluminate sealant is resistant to environmental attack caused by corrosive agents such as sulfates and/or chlorides of calcium, magnesium, sodium, etc., or mixtures thereof (e.g., from sea salt), or by oxides of calcium, magnesium, etc., or mixtures thereof, such as CMAS. In the case of aluminates such as calcium aluminate, the corrosion resistant sealant can also provide the EBC with resistance to attack by high temperature aqueous environments such as steam. As well as protecting the outer BSAS-containing barrier layer of the EBC from degradation, the alumina/aluminate sealant also protects less corrosion resistant layers of the EBC below the outer BSAS-containing barrier layer, such as the silicon/silica scale bond coat layer, as well as the silicon-containing substrate. For example, the corrosion resistant alumina/aluminate layer sealant can prevent premature spallation of the overlaying layers of the EBC from the underlying bond coat layer.

These corrosion resistant alumina/aluminate sealants are useful with a variety of articles comprising EBC systems having outer alkaline earth aluminosilicate (e.g., BSAS)-containing barrier layers for silicon-containing substrates where the article is operated at, or exposed to, high temperature, corrosive environments, especially higher temperature, corrosive environments that occur during normal gas turbine engine operation. These articles can be in the form of turbine engine (e.g., gas turbine engine) parts and components, including those comprising turbine airfoils such as turbine blades, vanes and blisks, turbine shrouds, turbine nozzles, combustor components such as liners, deflectors and their respective dome assemblies, augmentor hardware of gas turbine engines, etc. The corrosion resistant alumina/aluminate sealants used in the embodiments of this invention for EBC systems having outer alkaline earth aluminosilicate (e.g., BSAS)-containing barrier layers that overlie silicon-containing substrates are particularly useful for articles in the form of turbine blades and vanes, and especially the airfoil portions of such blades and vanes. However, while the following discussion of the embodiments of articles of this invention will be with reference to turbine blades and vanes, and especially the airfoil portions thereof, that comprise these blades and vanes, it should also be understood that these corrosion resistant alumina/aluminate sealants can be useful with other articles comprising silicon-containing substrates having overlaying EBC systems with outer alkaline earth aluminosilicate (e.g., BSAS)-containing barrier layers.

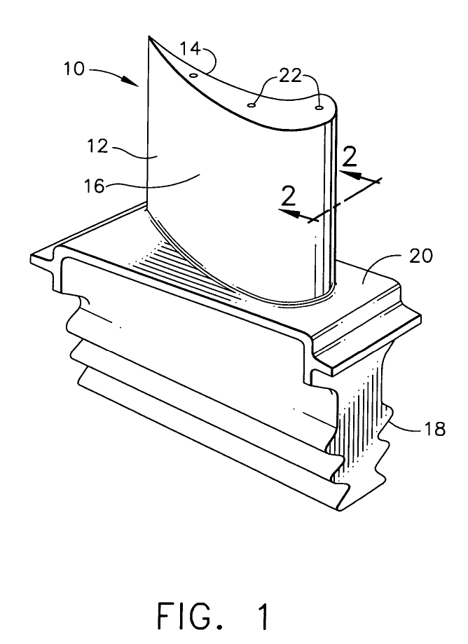

The various embodiments of this invention are further illustrated by reference to the drawings as described hereafter. Referring to the drawings, FIG. 1 depicts a component article of a gas turbine engine such as a turbine blade or turbine vane, and in particular a turbine blade identified generally as 10. (Turbine vanes have a similar appearance with respect to the pertinent portions.) Blade 10 generally includes an airfoil 12 against which hot combustion gases are directed during operation of the gas turbine engine, and whose surfaces are therefore subjected to potential environmental attack by corrosive agents such as sea salt or CMAS, as well as high temperature aqueous environments (e.g., steam). Airfoil 12 has a “high-pressure side” indicated as 14 that is concavely shaped; and a suction side indicated as 16 that is convexly shaped and is sometimes known as the “low-pressure side” or “back side.” In operation the hot combustion gas is directed against the high-pressure side 14. Blade 10 is anchored to a turbine disk (not shown) with a dovetail 18 formed on the root section 20 of blade 10. In some embodiments of blade 10, a number of internal passages extend through the interior of airfoil 12, ending in openings indicated as 22 in the surface of airfoil 12. During operation, a flow of cooling air is directed through the internal passages (not shown) to cool or reduce the temperature of airfoil 12.

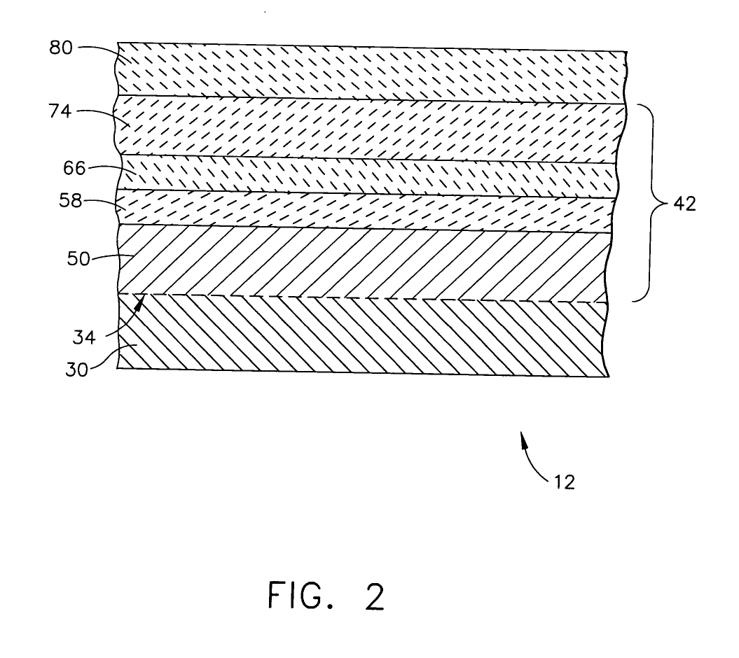

Referring to FIG. 2, the base material of airfoil 12 of blade 10 comprising the silicon-containing substrate is indicated generally as 30. Surface 34 of substrate 30 can be pretreated prior to forming the environmental barrier coating thereon to remove substrate fabrication contamination (e.g., cleaning surface 34) to improve adherence thereto, to provide a protective or adherent improvement silica scale on surface 34, etc. For example, substrate 30 can be pretreated by subjecting surface 34 to a grit blasting step. This grit blasting step is typically carried out carefully in order to avoid damage to surface 34 of substrate 30 such as silicon carbide fiber reinforced CMC substrate. The particles used for the grit blasting should also be hard enough to remove the undesired contamination but not so hard as to cause significant erosive removal of substrate 30. The abrasive particles typically used in grit blasting are sufficiently small to prevent significant impact damage to surface 34 of substrate 30. When processing a substrate 30, for example, a silicon carbide CMC substrate, grit blasting is typically carried out with alumina particles, typically having a particle size of about 30 microns or less, and typically at a velocity of from about 150 to about 200 m/sec.

As shown in FIG. 2, adjacent to and overlaying surface 34 of substrate 30 is an environmental barrier coating (EBC) indicated generally as 42. An embodiment of such an EBC 42 is disclosed in commonly assigned U.S. Pat. No. 6,410,148 (Eaton et al.), issued Jun. 25, 2002 (the relevant portions of which are herein incorporated by reference), especially at col. 3, line 6 through col. 4, line 17. Referring to FIG. 2, barrier coating 42 can comprise an optional inner layer 50 that is adjacent to and overlays surface 34, typically to provide a bond coat layer to improve adherence of EBC 42 to substrate 30, to provide a protective silica scale layer, to provide a seal coat, etc. This optional inner layer 50 typically has a thickness of from about 1 to about 10 mils (from about 25 to about 254 microns), more typically from about 1 to about 6 mils (from about 25 to about 152 microns). This optional inner layer 50 can comprise silicon to provide a bond coat layer, can comprise a silica scale to provide a protective and/or bond coat layer, can comprise a silicon-containing seal coat, such as a silicon carbide seal coat, etc. For example, it can be useful to preoxidize a small portion or fraction of the silicon-containing substrate 30 to form a protective silica scale inner layer 50. This preoxidized silica scale layer 50 can be formed, for example, by subjecting silicon-containing substrate 30 (e.g., a silicon-carbide substrate) to a temperature of from about 800° to about 1200° C. for from about 15 minutes to about 100 hours.

As further shown in FIG. 2, EBC 42 can also comprise an optional intermediate layer indicated generally as 58 that is adjacent to and overlaying inner layer 50 and underlying outer alkaline earth aluminosilicate barrier layer 66 (i.e., is between inner layer 50 and outer barrier layer 66), typically for the purpose or function of providing a reaction barrier between outer barrier layer 66 (comprising BSAS or some other alkaline earth aluminosilicate) and optional inner layer 50 or substrate 30 (containing silicon that can potentially react with the BSAS or other alkaline earth aluminosilicate in outer barrier layer 66 at higher operating temperatures) so as to prevent degradation of the adherence between outer barrier layer 66 and, for example, inner layer 50. This intermediate reaction barrier layer 66 typically has a thickness of from about 0.5 to about 10 mils (from about 13 to about 254 microns), more typically from about 1 to about 6 mils (from about 25 to about 152 microns). This optional intermediate layer 58 can comprise, for example, mullite, mullite-BSAS combinations, mullite-yttrium silicate combinations, mullite-calcium aluminosilicate combinations, etc., or combinations thereof. For example, these combinations can comprise from about 40 to about 80% mullite, with from about 20 to about 60% BSAS, yttrium silicate, calcium aluminosilicate, etc. This optional intermediate layer 58 typically consists essentially of mullite which provides a very satisfactory reaction barrier between alkaline earth aluminosilicates (e.g., BSAS) in outer barrier layer 66 and the silicon/silica scale in either inner layer 50 or substrate 30. This optional intermediate layer 58 can be formed by the use of conventional coating methods such as physical vapor deposition (PVD) techniques (e.g., electron beam physical vapor deposition (EB-PVD), ion plasma, etc.), thermal spray techniques (e.g., plasma spray, etc.), chemical vapor deposition (CVD) techniques, etc., as described hereafter for forming thermal barrier coatings, or as well known to those skilled in the art.

As further shown in FIG. 2, EBC 42 further comprises an outer alkaline earth aluminosilicate barrier layer indicated generally as 66 that is adjacent to and overlaying intermediate layer 58, typically for the purpose or function of providing protection against high temperature, aqueous environments (e.g., steam). This outer barrier layer 66 can have a thickness of at least about 0.5 mils (13 microns), and typically has a thickness of from about 1 to about 30 mils (from about 25 to about 762 microns), more typically from about 2 to about 8 mils (from about 51 to about 203 microns). This outer barrier layer 66 can be formed by the use of conventional coating methods such as physical vapor deposition (PVD) techniques (e.g., electron beam physical vapor deposition (EB-PVD), ion plasma, etc., thermal spray techniques (e.g., plasma spray such as air plasma spray, etc.), chemical vapor deposition (CVD) techniques, etc., as described hereafter for forming thermal barrier coatings, as well as slurry-gel coating deposition techniques, diffusion surface sintering or reaction sintering/bonding techniques, etc., as described hereafter with regard to forming the corrosion resistant alumina/aluminate sealant layer.

As further shown in FIG. 2, adjacent to and overlaying outer barrier layer 66 is an embodiment of the corrosion resistant alumina/aluminate sealant in the form of an outer corrosion resistant sealant layer indicated generally as 74. Outer corrosion resistant sealant layer 74 can have a thickness typically up to about 30 mils (about 762 microns), with thicker layers having a thickness more typically in the range of from about 2 to about 30 mils (from about 25 to about 762 microns). More typically, outer corrosion resistant sealant layer 74 is relatively thin. Such relatively thin outer corrosion resistant sealant layers 74 can have a thickness of up to about 3 mils (76 microns), with a thickness typically in the range of from about 0.08 to about 3 mils (from about 2 to about 76 microns). Corrosion resistant sealant layers 74 are typically formed to have relatively dense structures to protect EBC 42 and especially outer barrier layer 66 from environmental attack by corrosive agents (e.g., sulfate or chloride salts, and/or oxides such as CMAS). Suitable processes for making such dense structures for corrosion resistant sealant layer 74 include chemical vapor deposition (CVD) techniques, pack cementation techniques, etc., well known to those skilled the art, as well as physical vapor deposition (PVD) techniques (e.g., electron beam physical vapor deposition (EB-PVD), ion plasma, etc., thermal spray techniques (e.g., plasma spray such as air plasma spray, etc.), etc., for depositing thermal barrier coatings, as described hereafter, and in particular slurry-gel coating deposition techniques and reaction sintering/bonding techniques, as described hereafter.

In forming relatively thin corrosion resistant sealant layers 74, e.g., up to 3 mils (about 76 microns) in thickness, embodiments of the slurry-gel coating deposition process of this invention can be particularly useful. Slurry-gel coating deposition to form relatively thin corrosion resistant sealant layers 74 typically involves depositing particulates of the corrosion resistant alumina/aluminate material from a slurry or gel coating composition, followed by heating the deposited particulates to a sufficiently high temperature to fuse or sinter the particulates into a cohesive corrosion resistant sealant layer 74. See commonly assigned U.S. Pat. No. 5,759,032 (Sangeeta et al.), issued Jun. 2, 1998; U.S. Pat. No. 5,985,368 (Sangeeta et al.), issued Nov. 16, 1999; and U.S. Pat. No. 6,294,261 (Sangeeta et al.), issued Sep. 25, 2001 (the relevant portions of which are herein incorporated by reference) for suitable slurry-gel coating deposition techniques.

In addition to the particulates of the corrosion resistant alumina/aluminate material, the slurry or gel composition also includes a liquid carrier. Non-limiting examples of liquid carriers include water, lower alcohols (i.e., 1-4 carbon atoms in the main chain) such as ethanol, halogenated hydrocarbon solvents such as tetrachloromethane; and compatible mixtures of any of these substances. Selection of the liquid carrier depends on various factors such as: the evaporation rate required during subsequent processing; the effect of the carrier on the adhesion of the slurry or gel to the underlying outer barrier layer 66; the solubility of additives and other components in the carrier; the “dispersability” of the particulates (e.g., powders) in the carrier, as well as handling requirements; cost; availability; environmental/safety concerns, etc. The amount of liquid carrier is usually minimized while keeping the particulates of the slurry or gel in suspension. Amounts greater than that level may be used to adjust the viscosity of the slurry or gel composition, depending on the technique used to deposit the particulates from the slurry or gel.

The slurry or gel composition can be deposited by a variety of techniques well known in the art, including slip-casting, brush-painting, dipping, spraying, or spin-coating. Spray-coating is often the easiest way to deposit the particulates from the slurry or gel onto turbine components such as airfoils 12. The viscosity of the slurry or gel coating for spraying can be frequently adjusted by varying the amount of liquid carrier used.

After deposition of the particulates from the slurry or gel, the deposited particulates are then heated or fired to a sufficient temperature to fuse or sinter the particulates into a cohesive corrosion resistant sealant layer 74. The appropriate temperature for heating/firing the deposited particulates will of course depend on various factors, including the particular alumina/aluminate particulates in the slurry or gel composition. Typically, heating/firing the deposited particulates to a temperature in the range of from about 2200° to about 2400° F. (from about 1204° to about 1315° C.), more typically from about 2250° to about 2350° F. (from about 1232° to about 1288° C.) is usually sufficient to fuse and sinter the deposited particulates into a cohesive corrosion resistant sealant layer 74. Typically, the particle size of the alumina/aluminate particulates in the slurry that are deposited is from about 10 nanometers to about 10 microns. The particle size of the alumina/aluminate particulates should be selected based on the sintering ability (diffusion rates) for a given alumina/aluminate composition. Usually, finer (smaller) particle sizes are desirable to enable fusing and sintering deposited particulates into a cohesive sealant layer 74 when fired/heated within the previously indicated temperature ranges. Alternatively, such relatively thin corrosion resistant sealant layers 74 can be formed by an embodiment of the process of this invention involving reaction sintering/bonding wherein alumina oxide and metal oxide powders are combined in a slurry, followed by sintering of the deposited combined powders to form the corrosion resistant sealant layer 74. During this sintering step, the alumina and metal oxides in the deposited powder react to form the desired aluminate sealant layer 74.

In addition to providing relatively thin corrosion resistant sealant layers 74, embodiments of the slurry-gel coating deposition techniques of this invention, as well as well as embodiments of the reaction sintering/bonding techniques of this invention, can be used to form one or more layers of EBC 42 as relatively thin layers to obtain a relatively thin combination of corrosion resistant sealant layer 74 and EBC 42. For example, outer alkaline earth aluminosilicate barrier layer 66 could be formed in this manner. Alternatively, all of the layers (e.g., layers 50, 58 and 66) comprising EBC 42 can be formed in this manner.

Alternatively, the benefits of corrosion resistant sealant layer 74 can be achieved by treating a sufficiently porous outer barrier layer 66 with a precursor of the corrosion resistant alumina/aluminate material (e.g., an aluminum alkoxide for forming alpha-alumina), and then converting the infiltrated precursor within the porous outer barrier layer 66 to the corrosion resistant alumina/aluminate material such that the corrosion resistant alumina/aluminate material effectively seals the porous outer barrier layer 66 against environmental attack, combines with the alkaline earth aluminosilicates (e.g., BSAS) in porous outer barrier layer 66 (e.g., during conversion of the precursor) to form a sintered composite that is resistant to environmental attack, etc. See commonly assigned U.S. Published Patent Application No. 20040115470 (Ackerman et al.), published Jun. 17, 2004 (the relevant portions of which are incorporated by reference), which describes an embodiment of a suitable infiltration technique for forming infiltrated alumina, such as alpha-alumina. While the Ackerman et al. method discloses the formation of infiltrated alumina, such as alpha-alumina, it can also be used to infiltrate aluminate compounds, in particular such as tantalum aluminate and niobium aluminate, by appropriate modification.

In the Ackerman et al. method, a liquid infiltrating composition is formed that has dissolved or otherwise dispersed therein an alumina precursor capable of being converted to alumina, such as an aluminum alkoxide, aluminum β-diketonate, aluminum alkyl, alumina sol, etc., well known to those skilled in the art. See, for example, U.S. Pat. No. 4,532,072 (Segal), issued Jul. 30, 1985; U.S. Pat. No. 5,047,174 (Sherif), issued Sep. 10, 1991; U.S. Pat. No. (Spence et al.), issued Jun. 28, 1994; and U.S. Pat. No. 5,591,380 (Wright), issued Jan. 7, 1997, all of which are incorporated by reference. Some representative aluminum alkoxides suitable for use herein include aluminum methoxides, aluminum ethoxides, aluminum propoxides or isopropoxides, aluminum butoxides, aluminum sec-butoxides and mixtures thereof. See U.S. Pat. No. 4,532,072 (Segal), issued Jul. 30, 1985 and U.S. Pat. No. 5,591,380 (Wright), issued Jan. 7, 1997, both of which are incorporated by reference. These alumina precursors, in particular aluminum alkoxides, are usually soluble in water, or in combinations of water and polar organic liquid solvents such as alcohols, e.g., ethanol, methanol, isopropanol, and butanol, aldehydes, ketones, e.g., acetone, and other polar organic solvents, as well as mixtures of polar organic solvents, well known to those skilled in the art to form the liquid infiltrating composition. Typically, the liquid infiltrating composition comprises from about 5 to about 50% alumina precursor, more typically from about 10 to about 20% alumina precursor.

The liquid infiltrating composition can be poured, deposited or otherwise applied on or to porous outer barrier layer 66 in a manner such that the alumina precursor is able to soak in, be absorbed by and infiltrate the porous structure of outer barrier layer 66. The amount of liquid infiltrating composition that is used is such that the alumina precursor that infiltrates porous outer barrier layer 66 is sufficient to provide, when converted to alpha alumina, sufficient amount of corrosion resistant alpha alumina to protect porous outer barrier layer 66 against environmental attack. The period of time required for sufficient infiltration of the alumina precursor will depend on a variety of factors, including the particular liquid infiltrating composition used, the concentration of alumina precursor in liquid infiltrating composition, the manner in which liquid infiltrating composition is applied to porous outer barrier layer 66, the composition and structure of layer 66 and like factors well known to those skilled in the art. Typically, porous outer barrier layer 66 is treated with the liquid infiltrating composition for a period of time in the range from about 0.1 to about 30 minutes, more typically from about 1 to about 5 minutes.

After porous outer barrier layer 66 has been treated with the liquid infiltrating composition for a period of time sufficient to permit infiltration of the alumina precursor, the infiltrated alumina precursor within porous outer barrier layer 66 is then converted to alumina. The particular manner in which the infiltrated alumina precursor is converted to alumina will depend on a variety of factors, and particularly the type of alumina precursor used. In the case of aluminum precursors such as aluminum alkoxides, the infiltrated precursor is usually thermally converted in situ to alpha alumina. This is typically achieved by heating the infiltrated aluminum alkoxide to a temperature of at least about 1200° F. (649° C.), more typically in the range of from about 1200° to about 1500° F. (from about 649° to about 833° C.), for a sufficient period of time to convert the infiltrated aluminum alkoxide to alpha alumina, typically for at least about 2 hr., more typically for at least about 4 hr. Aluminum alkoxides that are thermally heated are typically converted to finely divided alpha alumina. During thermal conversion, the infiltrated alpha alumina may also combine or sinter with the alkaline earth aluminosilicates (e.g., BASA) in porous outer barrier layer 66 to form a sintered composite that is resistant to environmental attack.

As further shown in FIG. 2, EBC 42 can also be provided with an optional overlaying thermal barrier coating (TBC) comprising one or more thermal insulating layers comprising thermal barrier coating material and indicated generally as 80. TBC 80 is shown in FIG. 2 as being adjacent to corrosion resistant alumina/aluminate sealant layer 74 (if the alumina/aluminate sealant is infiltrated within outer barrier layer 66, TBC 80 would be adjacent to outer barrier layer 66), but can be provided with additional transition layers therebetween (i.e., between TBC 80 and corrosion resistant sealant layer 74) for CTE compatibility. See commonly assigned U.S. Pat. No. 6,444,335 (Wang et al.), issued Sep. 3, 2002 (the relevant portions of which incorporated by reference), for the use of such transition layers comprising BSAS, mullite and/or alumina with TBCs for CTE compatibility.

TBC 80 can have any suitable thickness that provides thermal insulating properties. TBCs 80 typically have a thickness of from about 1 to about 30 mils (from about 25 to about 769 microns), more typically from about 3 to about 20 mils (from about 75 to about 513 microns). TBC 80 (with or without transitional layers) can be formed on or over corrosion resistant sealant layer 74, by a variety of conventional thermal barrier coating methods. For example, TBCs 80 can be formed by physical vapor deposition (PVD), such as electron beam PVD (EB-PVD), filtered arc deposition, or by sputtering. Suitable sputtering techniques for use herein include but are not limited to direct current diode sputtering, radio frequency sputtering, ion beam sputtering, reactive sputtering, magnetron sputtering and steered arc sputtering. PVD techniques can form TBCs 80 having strain resistant or tolerant microstructures such as vertical microcracked structures. EB-PVD techniques can form columnar structures that are highly strain resistant to further increase the coating adherence. See, for example, U.S. Pat. No. 5,645,893 (Rickerby et al.), issued Jul. 8, 1997 (especially col. 3, lines 36-63) and U.S. Pat. No. 5,716,720 (Murphy), issued Feb. 10, 1998) (especially col. 5, lines 24-61) (all of which are incorporated by reference), which disclose various apparatus and methods for applying TBCs by PVD techniques, including EB-PVD techniques.

An alternative technique for forming TBCs 80 is by thermal spray. As used herein, the term “thermal spray” refers to any method for spraying, applying or otherwise depositing TBC 80 that involves heating and typically at least partial or complete thermal melting of the ceramic material and depositing of the heated/melted ceramic material, typically by entrainment in a heated gas stream, on corrosion resistant sealant layer 74. Suitable thermal spray deposition techniques include plasma spray, such as air plasma spray (APS) and vacuum plasma spray (VPS), high velocity oxy-fuel (HVOF) spray, detonation spray, wire spray, etc., as well as combinations of these techniques. A particularly suitable thermal spray deposition technique for use herein is plasma spray. Suitable plasma spray techniques are well known to those skilled in the art. See, for example, Kirk-Othmer Encyclopedia of Chemical Technology, 3rd Ed., Vol. 15, page 255, and references noted therein, as well as U.S. Pat. No. 5,332,598 (Kawasaki et al.), issued Jul. 26, 1994; U.S. Pat. No. 5,047,612 (Savkar et al.) issued Sep. 10, 1991; and U.S. Pat. No. 4,741,286 (Itoh et al.), issued May 3, 1998 (herein incorporated by reference) which describe various aspects of plasma spraying suitable for use herein, including apparatus for carrying out plasma spraying.

While specific embodiments of the this invention have been described, it will be apparent to those skilled in the art that various modifications thereto can be made without departing from the spirit and scope of this invention as defined in the appended claims.

What is claimed is:

1. An article comprising:
a silicon-containing substrate;
an environmental barrier coating overlying the substrate, wherein the environmental barrier coating comprises an outer alkaline earth aluminosilicate barrier layer; and
a corrosion resistant alumina/aluminate sealant for the outer barrier layer.

2. The article of claim 1 wherein the corrosion resistant alumina/aluminate sealant forms an overlaying layer adjacent to the outer barrier layer.

3. The article of claim 2 wherein the corrosion resistant alumina/aluminate sealant layer has a thickness up to about 30 mils.

4. The article of claim 3 wherein the corrosion resistant alumina/aluminate sealant layer has thickness of from about 0.08 to about 3 mils.

5. The article of claim 2 which further comprises a thermal barrier coating overlaying the corrosion resistant alumina/aluminate sealant layer.

6. The article of claim 1 wherein the corrosion resistant alumina/aluminate sealant is infiltrated within a porous outer barrier layer.

7. The article of claim 1 wherein the corrosion resistant alumina/aluminate sealant comprises alpha alumina.

8. The article of claim 1 wherein the corrosion resistant alumina/aluminate sealant comprises calcium aluminate, tantalum aluminate, niobium aluminate, scandium aluminate, yttrium aluminate, lanthanum aluminate, dysprosium aluminate, holmium aluminate, erbium aluminate, thulium aluminate, ytterbium aluminate, lutetium aluminate, cerium aluminate, praseodymium aluminate, neodymium aluminate, promethium aluminate, samarium aluminate, europium aluminate, gadolinium aluminate, terbium aluminate, or compatible combinations thereof.

9. The article of claim 8 wherein the corrosion resistant aluminate sealant comprises calcium aluminate.

10. The article of claim 1 wherein the substrate comprises a silicon-containing ceramic material, a silicon metal alloy, or a combination thereof.

11. The article of claim 10 wherein the substrate comprises a continuous matrix of a silicon-containing material reinforced with fibers.

12. The article of claim 11 wherein the substrate comprises a silicon carbide coated silicon carbide fiber-reinforced silicon carbide particles and a silicon matrix, a carbon fiber-reinforced silicon carbide matrix, or a silicon carbide fiber-reinforced silicon nitride matrix.

13. The article of claim 10 wherein the substrate comprises a silicon-containing ceramic material.

14. The article of claim 13 wherein the silicon-containing ceramic material comprises silicon carbide, silicon nitride, silicon carbide nitride, silicon oxynitride, silicon aluminum oxynitride, or a combination thereof.

15. The article of claim 1 wherein the outer barrier layer consists essentially of a barium strontium aluminosilicate.

16. The article of claim 15 wherein the barium strontium aluminosilicate comprises at least an outer surface region consisting essentially of a first stoichiometric crystalline phase of barium strontium aluminosilicate that is substantially free of a nonstoichiometric second crystalline phase of barium strontium aluminosilicate.

17. The article of claim 1 wherein the environmental barrier coating further comprises a reaction barrier layer comprising mullite between the outer barrier layer and the substrate.

18. The article of claim 17 wherein the reaction barrier layer consists essentially of mullite.

19. The article of claim 18 wherein the environmental barrier coating further comprises an inner layer comprising silicon or silicon scale overlaying and adjacent to the substrate, and wherein the reaction barrier layer overlies and is adjacent to the inner layer.

20. The article of claim 19 wherein the inner layer has a thickness of from about 1 to about 6 mils.

21. The article of claim 1 which is in the form of a turbine component.

22. A process comprising the following steps:
(a) providing a silicon-containing substrate having an overlaying environmental barrier coating comprising an outer alkaline earth aluminosilicate barrier layer; and
(b) forming a corrosion resistant alumina/aluminate sealant layer over the outer barrier layer.

23. The process of claim 22 wherein the corrosion resistant alumina/aluminate sealant layer is formed to have a thickness of up to about 3 mils.

24. The process of claim 23 wherein step (b) comprises: (1) depositing a particulate corrosion resistant alumina/aluminate material from a slurry or gel coating composition; and (2) heating the deposited particulates to form the corrosion resistant alumina/aluminate sealant layer.

25. The process of claim 24 wherein the outer alkaline earth aluminosilicate barrier layer of step (a) is formed by: (1) depositing a particulate alkaline earth aluminosilicate material from a slurry or gel coating composition, and (2) heating the deposited particulates to form the outer alkaline earth aluminosilicate barrier layer.

26. The process of claim 22 wherein the corrosion resistant alumina/aluminate sealant layer is formed to have a thickness of up to about 30 mils.

27. The process of claim 26 wherein step (b) is carried out by plasma spray.

28. A process comprising the following steps:
(a) providing a silicon-containing substrate having an overlaying environmental barrier coating comprising a porous outer alkaline earth aluminosilicate barrier layer;
(b) treating the porous outer barrier layer with a liquid composition comprising a corrosion resistant alumina/aluminate sealant precursor to infiltrate the porous outer barrier layer with the alumina/aluminate sealant precursor in an amount sufficient to provide, when converted to the corrosion resistant alumina/aluminate sealant, protection of the environmental barrier coating against environmental attack; and
(c) converting the infiltrated alumina/aluminate sealant precursor within the porous outer barrier layer to the corrosion resistant alumina/aluminate sealant.

29. The process of claim 28 wherein the liquid composition comprises from about 5 to about 50% alumina precursor.

30. The process of claim 29 wherein the alumina precursor is an aluminum alkoxide selected from the group consisting of aluminum methoxides, aluminum ethoxides, aluminum propoxides, aluminum isopropoxides, aluminum butoxides, aluminum sec-butoxides and mixtures thereof.

31. The process of claim 30 wherein step (c) comprises heating the infiltrated aluminum alkoxide to a temperature of at least about 1200° F. for a period of at least about 2 hours.

32. The process of claim 28 wherein the porous outer barrier layer is treated with the liquid composition for a period of from about 0.1 to about 30 minutes.
